(19) United States
(12) Patent Application Publication
(10) Pub. No.: US 2003/0054971 A1
(43) Pub. Date: Mar. 20, 2003

(54) Detergent composition in tablet form

(75) Inventors: Paul William Robinson, North Ferriby (GB); Guido Waeschenbach, Oakland, NJ (US); Brendan Collins, Wiesbaden (DE); Ralf Wiedemann, Griesheim (DE); Enric Carbonell, Brussels (BE); Richard Neergaard, Beussels (BE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Reckitt Benckiser N.V.

(21) Appl. No.: 10/215,674

(22) Filed: Aug. 9, 2002

Related U.S. Application Data
(63) Continuation of application No. PCT/GB01/00532, filed on Feb. 9, 2001.

(30) Foreign Application Priority Data
Feb. 9, 2000 (DE) 100 05 574.5

(51) Int. Cl. C11D 17/00; C11D 17/06

(52) U.S. Cl. 510/446; 510/447; 510/224

(57) ABSTRACT

A detergent composition is provided in tablet form which contains at least one tablet. Each tablet contains a substantially complete detergent formulation for a washing application and weighs about 5 to about 700 mg.

### CROSS-REFERENCE TO RELATED APPLICATIONS

This application is a continuation of International Patent Application No. PCT/GB01/00532, filed Feb. 9, 2001, which was published in the English language on Aug. 16, 2001, under International Publication No. WO 01/59058, and the disclosure of which is incorporated herein by reference.

### BACKGROUND OF THE INVENTION

The present invention relates to a detergent composition in tablet form which may be used for a variety of washing applications.

Detergent compositions, such as detergents for dish-washing machines and for laundry washing machines, are nowadays available in three different presentations.

The traditional presentation, which is still the most common even today in laundry detergents, for example, consists of powder or granules in which the average particle size ranges from about 0.1 to about 2 mm in diameter. It is standard for powder or granules, both in a dishwasher and in a washing machine, to be washed out of an appropriate chamber by water, in which the chamber opens during the washing cycle. Because of the hygroscopic nature of the powder or granules, lumps occasionally form, so that the amount of detergent used may be too small. Therefore, certain ingredients such as paraffin have been added to the detergent composition to prevent the formation of such lumps, but such a method may not be successful in all cases.

In addition, laundry and other detergent granules are known from European Patent EP 0 486 592 B1, for example, which are prepared by extrusion, i.e., involving the plasticizing of a pre-mix. Such a method restricts the choice of substances that can be processed and necessitates the addition of a plasticizer. Moreover, because of the substances used and the manufacturing method employed, the solubility of extrudates is usually poorer than that of tablets, which are manufactured by pressing or compacting, for example, especially because of the smaller surface area they exhibit as a result of the absence of porosity.

A second presentation is liquid detergents, though their cleaning power does not match that of conventional powders or granules.

For some years now, detergents in tablet form have been available on the market and, in the case of dishwasher detergents, for example, they have in the meantime actually overtaken the other types. These tablets are usually manufactured from the same ingredients as the known powders or granules, sometimes with the addition of tabletting aids. The problems with the formation of lumps which were known from powders and granules cannot occur with these tablets, which usually contain the full amount needed for one washing cycle, so that, in each case, only one (or a small number of) tablet(s) need(s) to be used for each washing cycle. Furthermore, the use of detergent tablets avoids the need to measure out powder or granules, which can sometimes be complicated and tiresome. There is admittedly one disadvantage compared to the use of powder or granules, namely the reduced flexibility in measuring out the required quantity, since it is usual for the same amount of detergent to be added to every washing cycle, which is determined by the size of the tablet, irrespective of whether the crockery or laundry is heavily or lightly soiled and whether the machine is being operated with a full or reduced load.

A dishwasher detergent in tablet form is known from European published patent application EP 0 318 204 A1, which consists of a combination of at least two types of tablets in which incompatible components are distributed among these tablet types in such a way that substantially no incompatible ingredients are formulated in the same tablet type. In a preferred embodiment, one tablet type contains builders and enzyme(s), for example, whereas the second tablet type contains silicate and bleach. In this case, the tablets of each tablet type are usually smaller than conventional tablets, since the different ingredients are distributed between two tablet types. The weight is stated to be 0.2 to 40 g, preferably 0.5 to 5 g per tablet.

The different tablet types can either be offered separately and mixed in the correct proportions by the user or provided as a pre-mixed product. In the first case, a difficulty arises from maintaining the correct proportions between the various tablet types when measuring out the amount required; in the second case, problems occur if the tablet types become unevenly distributed in the mixture or if they are separated during transport or storage.

There is therefore a need in the art to provide a detergent composition which overcomes the disadvantages of powder or granules as described and which at the same time offers improved flexibility in measuring out the appropriate amount compared to conventional tablets.

### BRIEF SUMMARY OF THE INVENTION

In order to solve the problem described above and to avoid the disadvantages of the state of the art just described, a detergent composition in tablet form is provided which comprises at least one tablet, in which each tablet contains a substantially complete detergent formulation for a washing application and weighs about 5 to about 700 mg.

### DETAILED DESCRIPTION OF THE INVENTION

Before turning to a detailed description of the composition of the invention, it should first of all be pointed out that the terms “detergent composition” and “detergent” may be understood in a broad sense in the present application, namely as comprising all those substances and mixtures of substances which can be used in connection with cleaning processes. These include not only the compositions which are actually active in cleaning, such as dishwasher detergents and washing substances, but also compositions which support the cleaning functions concerned, such as water softeners, or which have the effect of providing protective care, such as fabric softeners or final rinses.

It is preferred if each tablet according to the present invention weighs less than about 600 mg, more preferably less than about 400 mg, and most preferably less than about 250 mg. Preferably each tablet weighs more than about 10 mg, more preferably more than about 20 mg and most preferably more than about 40 mg. In a preferred embodiment of the invention, each individual tablet weighs about 50 to about 150 mg.

The detergent composition of the invention can be used in a variety of ways in appropriate (effective) quantities or dosages, e.g., as a dishwasher detergent, in the final rinse in a dishwasher, as a detergent in a washing machine, as a detergent for hand-washing laundry, as a water softener or fabric conditioner in a washing machine, as a bleach enhancer in a washing machine or dishwasher, or as a descaling agent. It goes without saying that other possible uses are conceivable and are also encompassed.

The detergent composition of the invention possesses a wide range of advantages both over conventional powders and granules and over conventional tablets.

The presentation in the form of tablets, which are preferably manufactured by pressing or compacting, can make a substantial reduction possible in the amount of dust formed in the case of powders and granules, both in manufacturing and packaging, and in use. In contrast to powders and granules, the small tablets of the invention tend less to coagulate, both in storage and in the machine chamber (especially when predissolved therein), since they are less sensitive to moisture. With the tablet form of the detergent composition of the invention, it is also possible to have better control over solubility, for example, by providing components or a coating which delays dissolution, or by pressing or compacting under high pressure. Embodiments of the invention include tablets prepared by compacting a starting material or by pressing a pulverulent starting material.

As a result of the fact that the tablets of the invention are larger than conventional powders or granules, they are not completely removed from the machine during the pumping stage after the main washing stage or the intermediate rinsing stages, so that ingredients may be included which are not intended to develop their effect until the final rinsing stage.

A further problem with powders and granules, namely the separation of fine particles that inevitably occurs during manufacture which prevents the uniform distribution of ingredients, can likewise be avoided by using the composition of the invention. Finally, there is also greater flexibility with regard to the choice of components, because components can also be included which are not readily miscible into powders or granules—substances with a certain stickiness, for example, such as surfactants.

A similarly enhanced flexibility also exists compared to detergent granules prepared by extrusion, since the pressures and temperatures necessary for that process restrict the choice of starting materials that can be used and make it necessary to add a plasticizer.

Compared to conventional detergent tablets, the composition of the invention can be metered more flexibly, flexibility which is not in principle inferior to the flexibility of powders and granules. In order to manufacture the small tablets of the composition of the invention, it is also possible to use procedures other than conventional tabletting, such as compacting, which is also understood to include agglomeration under pressure without the use of binders. Therefore, there is also greater flexibility with regard to the manufacturing process.

Since the small tablets according to the present invention have a larger surface area than conventional large tablets, it is possible to spray on more material or to apply it by means of other coating methods. Because of their higher surface-to-volume ratio, the tablets of the detergent composition of the invention are more rapidly soluble than conventional detergent tablets, e.g. even in water at lower temperatures, such as for hand-washing detergents. For this reason, it is also possible to include more poorly soluble substances (especially such as surfactants), optionally employing an effervescent system in order to enhance solubility still further.

In the case of perfume substances which are conventionally added to detergent compositions, the fact that they are worked into the tablets leads to better retention than in the case of powders and granules, and secondly the larger surface area allows the perfume to develop a better effect in the washing process than in the case of conventional tablets.

Because of the smaller dimensions of the tablets of the invention, better use can be made of the space available during storage and packaging than with conventional tablets. Furthermore, the smaller tablets are less susceptible to breakage and can be more easily removed from the machine chamber and distributed in the machine. The problem which occasionally occurs with dishwasher detergent tablets, namely that the tablets become stuck between pieces of crockery and do not dissolve correctly as a result, is likewise reliably avoided.

The starting material for the detergent compositions of the invention in tablet form may be formulated in the same way as conventional powders, granules or tablets. A suitable formulation may therefore comprise a large number of different ingredients, including builders, surfactants, enzymes, bleaches, bleach activators, sources of alkalinity, dyes, perfumes, dispersants for lime soaps, organic polymers, including polymers to inhibit color transfer, crystal growth inhibitors, complexing agents for heavy metal ions, salts, enzyme stabilizers, corrosion inhibitors, solvents, fabric softeners, optical brighteners, hydrotropic agents, etc.

In addition, the compositions may contain suitable fillers, such as sulfates and carbonates, and tabletting aids, such as polyethylene glycol, starch or starch derivatives, etc.

In a preferred embodiment, the tablets may be provided with or surrounded by a water soluble coating whose nature may be determined by the purpose for which it is intended. Any water-soluble polymer can be provided for a coating, for example, if the purpose of the coating is to provide greater stability during storage and handling and/or a certain delay in dissolution in the wash liquor. For example, if the aim of the delay is so that the ingredients may be released during a certain phase of the washing cycle, as is the case with formulations for the final rinse of machine rinsing, pH-dependent coating materials can be used, such as those described in German published patent application DE 198 34 180.6.

The tablets can also contain a scattering agent or effervescent system, such as a combination of bicarbonate of soda and citric acid, in order to support the rapid dissolution of the tablets, especially when poorly soluble ingredients are included.

A major criterion of the detergent composition of the invention in tablet form is the mass (or a related parameter) of the individual tablets, which is preferably about 5 to about 700 mg and more preferably about 50 to about 150 mg. The tablets may have various shapes, such as spherical, cylindrical, ellipsoid, etc. In the case of a spherical design, the preferred diameter is about 2 mm to about 10 mm.

The detergent tablets of the present invention may be manufactured using a variety of processes, including normal pressing under pressure. Depending on the demands placed on the dissolution behavior and stability in storage and transport, and depending on the nature of the ingredients, the appropriate pressing pressure can be set accordingly.

A further preferred manufacturing process is compacting, which is understood in this application to mean pressing agglomeration without the use of binders, which is usually performed by rollers rotating in opposite directions and possessing grooves of the appropriate dimensions. With this production process, it is also possible to use other ingredients, which are usually not suitable for pressing, because the pressures during compacting are considerably lower.

Washing and detergent granules manufactured by extrusion, i.e. by plasticizing a premix, as described in European patent EP 0 486 592 B1, which has been mentioned above, are not regarded as tablets for the purposes of the present application.

The detergent composition of the invention may be used in a variety of ways, including as a dishwasher detergent, as a final rinse in dishwashers, as a detergent in a washing machine or for a hand wash, as a water softener or fabric softening rinse in a washing machine, as a bleach enhancer, or as a descaling agent. Other fields of use in the detergent sector are conceivable and possible, such as use as a detergent composition for dissolution in water for cleaning hard surfaces, such as floors. The tablets may thus contain appropriate (i.e., effective for the purpose) dosages of dishwashing detergent, laundry detergent, water softener, fabric conditioner, bleach enhancer or descaling agent, for example, depending on the desired washing application.

The features of the invention disclosed in the above description and in the claims can be essential, both alone and in any combination, for carrying out the invention in its various embodiments.

The invention will now be described with reference to the following examples.

### EXAMPLE 1

Water Softening Tablets

Equipment used: Roller compactor

Single layer and double layer(divided hopper) briquettes were produced

Size of tablettinos: Weight=100 mg

Water softener tab formula (% w/w)

| Ingredients | Total | White Layer | Blue Layer |
|---|---|---|---|
| citrate | 56.120 | 52.730 | 62.890 |
| polymer | 22.770 | 22.770 | 22.770 |
| PEG 6000 | 3.000 | 3.000 | 3.000 |
| cellulose | 4.500 | 4.500 | 4.500 |
| cellulose | 2.500 | 2.500 | 2.500 |
| sulfate | 8.350 | 12.520 | 0.000 |
| silicate | 0.660 | | 2.000 |
| Dye | 0.005 | | 0.016 |
| PEG 200 | 0.115 | | 0.344 |
| Water | 1.980 | 1.980 | 1.980 |
| Total | 100.000 | 100.000 | 100.000 |

Manufacturing Instructions:

White Powder Mixture

Add the raw materials to the Lödige Mixer in the above order while the mixer works at 20% speed. Mix for 30 seconds with mixer at 50% speed and check versus specification. Protect from heat and humidity.

Blue Powder Mixture

Add raw materials 1 to 6 to the Ruberg Mixer in the above order while mixing at 50% speed.

Spray on the color pre mix over 1 minute while continuing to mix.

Remove the fuel injector, then mix for 3 minutes at 50% speed. The color should appear homogeneous.

Check the specification's data and fill in two big bags, close and protect against heat and humidity. Process the mix within 4 weeks max.

Color Pre Mix

| Ingredients | % w/w |
|---|---|
| Polyethylene Glycol 200 | 95.667 |
| dye | 4.333 |

Mixer must be dry. Add the ingredients. Mix for 5 minutes. The liquid should appear homogeneous. Store in closed containers.

### EXAMPLE 2

Equipment used: Roller compactor

Double layer(divided hopper) tablettinos were produced

Size of tablettinos:

Length=9 mm

Width=6 mm

Thickness=4.35 mm

Weight=0.27 g

Formula: Double Layer Briquettes (% weight/weight)

| Layers | NaCl | Organic Acid | PEG 600 | Dye |
|---|---|---|---|---|
| White | 98 | 0 | 2 | 0 |
| Blue | 90.725 | 7.2 | 2 | 0.075 |
| White | 98 | 0 | 2 | 0 |
| Blue | 90.7 | 7.2 | 2 | 0.1 |
| White | 98 | 0 | 2 | 0 |
| Blue | 90.775 | 7.2 | 2 | 0.025 |
| White | 98 | 0 | 2 | 0 |
| Blue | 90.76 | 7.2 | 2 | 0.04 |
| White | 98 | 0 | 2 | 0 |
| Blue | 90.79 | 7.2 | 2 | 0.01 |
| White | 98 | 0 | 2 | 0 |
| Blue | 90.75 | 7.2 | 2 | 0.05 |

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention as defined by the appended claims.

We claim:

1. A detergent composition in tablet form comprising at least one tablet, wherein the at least one tablet comprises a substantially complete detergent formulation for a washing application and weighs about 5 to about 700 mg.

2. The detergent composition according to claim 1, wherein the at least one tablet weighs about 50 to about 150 mg.

3. The detergent composition according to claim 1, wherein the at least one tablet comprises a pressed pulverulent starting material.

4. The detergent composition according to claim 1, wherein the at least one tablet comprises a compacted starting material.

5. The detergent composition according to claim 1, further comprising a water-soluble coating, wherein the at least one tablet is surrounded by the coating.

6. The detergent composition as in claim 1, wherein the at least one tablet contains an appropriate dosage of a dishwasher detergent.

7. The detergent composition as in claim 1, wherein the at least one tablet contains an appropriate dosage of a dishwasher final rinse detergent.

8. The detergent composition as in claim 1, wherein the at least one tablet contains an appropriate dosage of a washing machine laundry detergent.

9. The detergent composition as in claim 1, wherein the at least one tablet contains an appropriate dosage of a hand-washing laundry detergent.

10. The detergent composition as in claim 1, wherein the at least one tablet contains an appropriate dosage of a washing machine water softener.

11. The detergent composition as in claim 1, wherein the at least one tablet contains an appropriate dosage of a washing machine fabric conditioner.

12. The detergent composition as in claim 1, wherein the at least one tablet contains an appropriate dosage of a washing machine or dishwasher bleach enhancer.

13. The detergent composition as in claim 1, wherein the at least one tablet contains an appropriate dosage of a descaling agent.
